(19) United States
(12) Patent Application Publication
(10) Pub. No.: US 2014/0147009 A1
(43) Pub. Date: May 29, 2014

(54) SYSTEM AND METHOD FOR MEASURING FEATURES OF PLANT BY PLANT IMAGES AND RECORDING MEDIUM

(71) Applicant: INSTITUTE FOR INFORMATION INDUSTRY, Taipei City (TW)

(72) Inventors: Yung-Hsing PENG, Kaohsiung City (TW); Po-Cheng HUANG, Yunlin County (TW); Wei-Chung CHEN, New Taipei City (TW); Yen-Dong WU, Tainan City (TW); Yao-Yang KU, Tainan City (TW)

(73) Assignee: INSTITUTE FOR INFORMATION INDUSTRY, Taipei City (TW)

(21) Appl. No.: 13/714,145

(22) Filed: Dec. 13, 2012

(30) Foreign Application Priority Data
Nov. 27, 2012 (TW) 101144339

(51) Int. Cl. G06K 9/46

(52) U.S. Cl. CPC G06K 9/46
USPC 382/106; 382/110

(57) ABSTRACT

A system for measuring features of plant by plant images is provided, which includes an image display module, a measurement specifying module and a computing module. The image display module is used for displaying at least one plant image. The measurement specifying module is used for specifying at least two measurement points on each of the plant images and a relation between the measurement points. The computing module is used for calculating at least one piece of plant features of the plant image according to the specified positions of the measurement points and the relation between the measurement points.

### CROSS-REFERENCE TO RELATED APPLICATION

This application claims the benefit of Taiwan Patent Application No. 101144339, filed on Nov. 27, 2012, which is hereby incorporated by reference for all purposes as if fully set forth herein.

### BACKGROUND OF THE INVENTION

1. Field of Invention

The present invention relates to a system and a method for measuring features of plant by plant images and a recording medium, and more particularly to a system and a method for obtaining features of plant images by specifying at least two measurement points and a relation thereof on the plant images and a recording medium.

2. Related Art

In the prior art, a grower measures features of a plant physically, records plant growth data, and merges the plant growth data of the plant in different growth periods into a plant growth record. Then, in order to improve the reliability of the plant growth record, the grower captures a plurality of plant images in similar environment on different growth periods of the plant to measure features of the plant images, so that a computer system can automatically determine a growth condition of the plant or whether the plant suffers from a disease or pest, which may further be stored as the plant growth record.

However, in order to accurately find the part to be measured in the image, it is necessary to collect a large amount of image data and perform data training in advance in the conventional image analysis and recognition method. The execution efficiency of such method is low, and the accuracy of recognition is often poor. In addition, there are many differences in different plants. The implementation cost will be increased greatly if it needs to collect image data and perform data training respectively for each plant. Moreover, the existing plant growth record is mainly for keeping the data. Sometimes, there are plant images for reference, but the plant growth record often fails to which specify the position measured on the plant image. Therefore, it is difficult to verify the accuracy of the plant growth records. Furthermore, since a different position in the plant image may be measured each time, the growth estimation cannot be achieved according to the previously recorded growth data.

### SUMMARY OF THE INVENTION

Accordingly, the present invention is directed to a system and a method for measuring features of plant by plant images and a recording medium, which can greatly improve the accuracy of measurements and reduce the time and procedures required for image recognition and calculation of plant features by specifying and adjusting measurement points to accurately obtain or adjust plant features of plant by plant images. Especially when the present invention is applied to different species of plants, it is only required to specify measurement points for each species of plants, and after the corresponding species is determined, plant features can be obtained rapidly. Further, the plant features obtained by specifying measurement points can be used as a plant growth record, used to verify the accuracy of data in the plant growth record and estimate a growth function.

The present invention provides a system for measuring features of plant by plant images, which comprises an image display module, a measurement specifying module and a computing module. The image display module is used for displaying at least one plant image. The measurement specifying module is used for specifying at least two measurement points on each of the plant images and a relation between the measurement points. The computing module calculates at least one piece of plant features of the at least one plant image according to the at least two measurement points and the relation between the at least two measurement points.

The present invention provides a method for measuring features of plant by plant images, which comprises: displaying at least one plant image by an image display module; specifying at least two measurement points on the at least one plant image and a relation between the measurement points by a measurement specifying module; and calculating at least one piece of plant features of the plant image according to the relation between the measurement points by a computing module.

The present invention also provides a recording medium, storing a program code readable by an electronic device. When reading the program code, the electronic device performs a method for measuring features of plant by plant images. The method is as described above.

Firstly, in the present invention, by presenting plant images and measurement points, a user can easily understand the recording basis of the plant growth record, and if necessary, properly adjust the measurement points and relation thereof to obtain plant features of the plant image that conforms to the actual growth condition of the plant, and properly correct the plant growth record according to the plant features, so as to improve the accuracy of data in the plant growth record. Secondly, the plant images of the plant that are captured in different growth periods and the measurement points corresponding to the plant images can be used to estimate the growth trend of the plant, so as to accurately evaluate the growth of the plant. Thirdly, through operation of the image display module and the measurement specifying module, the user is able to directly specify measurement points on the image, which not only makes it flexible to specify measurement points, but also can reduce the operational complexity for the user. The technology disclosed in the present invention is applicable to the existing plant growth recording system or equipment capable of recording growth images without significantly changing the hardware, which shows the applicability and compatibility of the technology of the present invention.

### BRIEF DESCRIPTION OF THE DRAWINGS

The present invention will become more fully understood from the detailed description given herein below for illustration only, and thus are not limitative of the present invention, and wherein:

FIG. 1A is a schematic view of a system for measuring features of plant by plant images according to a first embodiment of the present invention;

FIG. 1B is a schematic view of a system for measuring features of plant by plant images according to a second embodiment of the present invention;

FIG. 2A is a first schematic front view image of a plant according to an embodiment of the present invention;

FIG. 2B is a first schematic top view image of a plant according to an embodiment of the present invention;

FIG. 3A is a second schematic front view image of a plant according to an embodiment of the present invention;

FIG. 3B is a second schematic top view image of a plant according to an embodiment of the present invention;

FIG. 4A is a third schematic front view image of a plant according to an embodiment of the present invention;

FIG. 4B is a third schematic top view image of a plant according to an embodiment of the present invention;

FIG. 5A and FIG. 5B are schematic views illustrating specifying of subsequent measurement point according to an embodiment of the present invention;

FIG. 6 is a schematic view of a system for measuring features of plant by plant images according to a third embodiment of the present invention;

FIG. 7 is a schematic view of a system for measuring features of plant by plant images according to a fourth embodiment of the present invention;

FIG. 8 is a schematic flowchart of a method for measuring features of plant by plant images according to an embodiment of the present invention; and

FIG. 9 and FIG. 10 are schematic subsequent flowcharts of a method for measuring features of plant by plant images according to an embodiment of the present invention.

### DETAILED DESCRIPTION OF THE INVENTION

Preferred embodiments of the present invention are described in detail below with reference to the accompanying drawings.

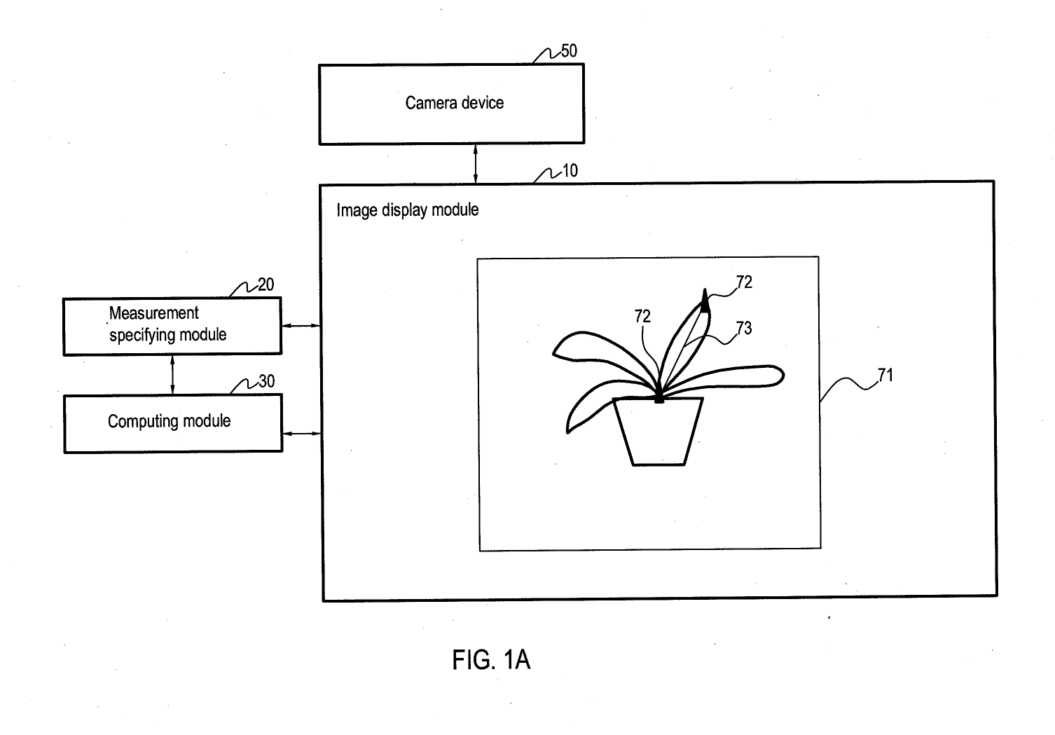

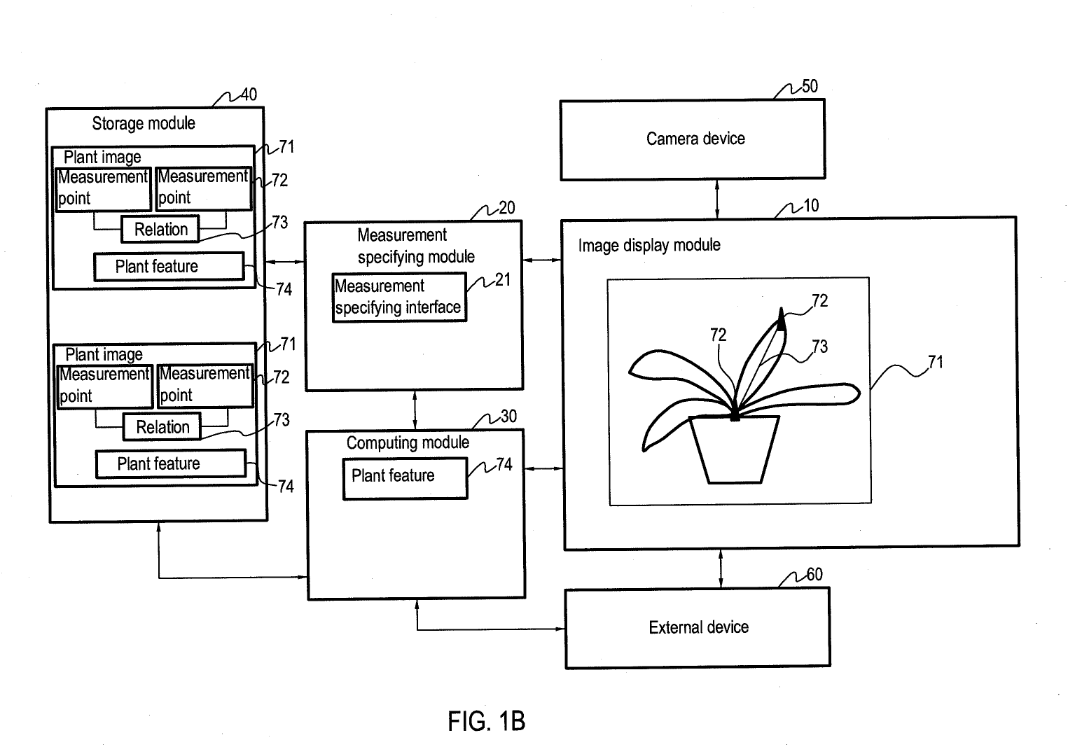

FIG. 1A is a schematic view of a system for measuring features of plant by plant images according to a first embodiment of the present invention, and FIG. 1B is a schematic view of a system for measuring features of plant by plant images according to a second embodiment of the present invention. Referring to FIG. 1A and FIG. 1B, the systems mainly include an image display module 10, a measurement specifying module 20 and a computing module 30.

The image display module 10 is used for displaying at least one plant image 71. The plant image(s) 71 may be images for different plants, or images for a plant on different angles. The image display module 10 may display one plant image 71 each time, or may simultaneously display a plurality of plant images 71. Further, as shown in FIG. 1B, the plant image 71 may be captured by any camera 50 having video recording and image capture functions, such as a digital camera or a digital video camera. In some embodiments, the plant image 71 may be stored in an external device 60 having a storage, which provides the plant image 71 to the image display module 10 after being connected to the image display module 10. In some other embodiments, the external device 60 may be connected the computing module 30. The computing module 30 reads the plant image stored in the external device 60 and then instructs the image display module 10 to preset the plant image. In still some embodiments, the system may also include a storage module 40 for storing the plant image 71.

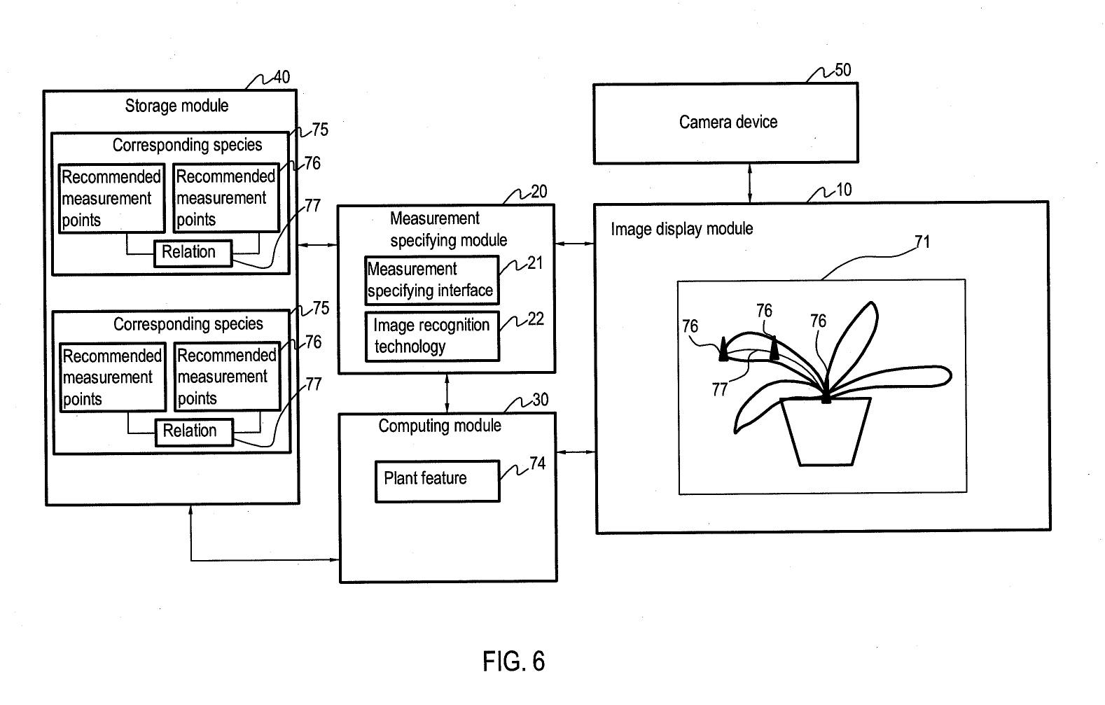

The measurement specifying module 20 is used for specifying two or more measurement points 72 on each plant image 71, and specifying a relation 73 between the measurement points 72. In some embodiments, the measurement specifying module 20 may provide a measurement specifying interface 21 for a user specifying the measurement point 72 on the plant image 71 and the relation 73 between the measurement points 72. In some other embodiments, as shown in FIG. 6, the measurement specifying module 20 may automatically recognize a measured part of the plant image by using an ordinary image recognition technology 22, and find and display measurement points according to required conditions of plant image features. For example, the measurement specifying module 20 can recognize a leaf as the measured part in the plant image, and then find the tip and root of the leaf as the measurement points.

However, the relation 73 includes at least the following:

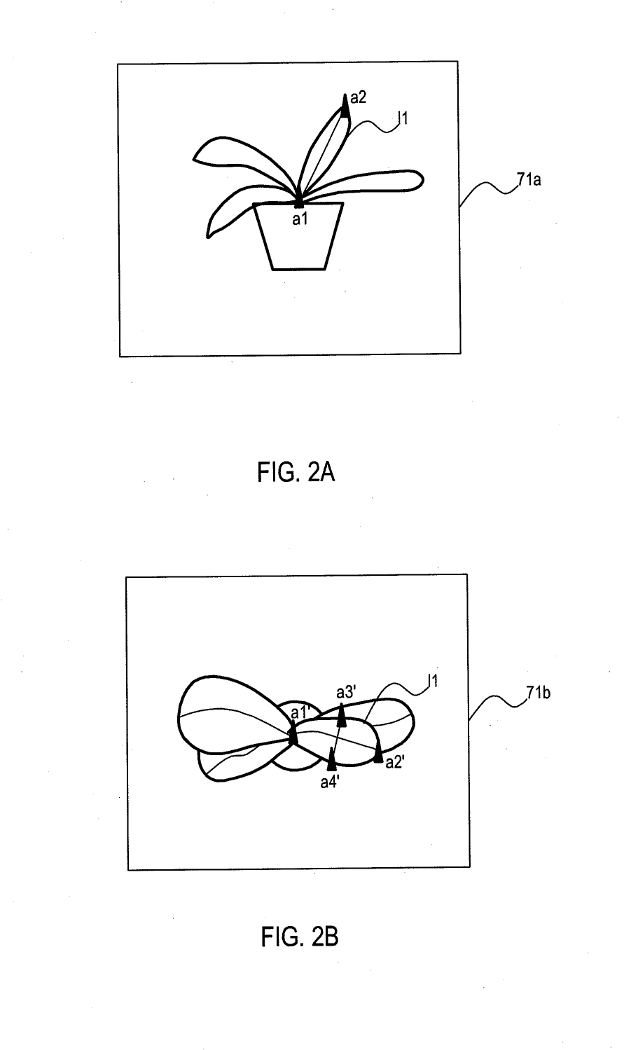

(1) A straight line formed by connecting two measurement points 72. In FIG. 2A, it is a first schematic front view image of a plant according to an embodiment of the present invention, where a measurement point a1 and a measurement point a2 are connected to form a straight line. In FIG. 2B, it is a first schematic top view image of a plant according to an embodiment of the present invention, where a measurement point a3′ and a measurement point a4′ are connected to form a straight line.

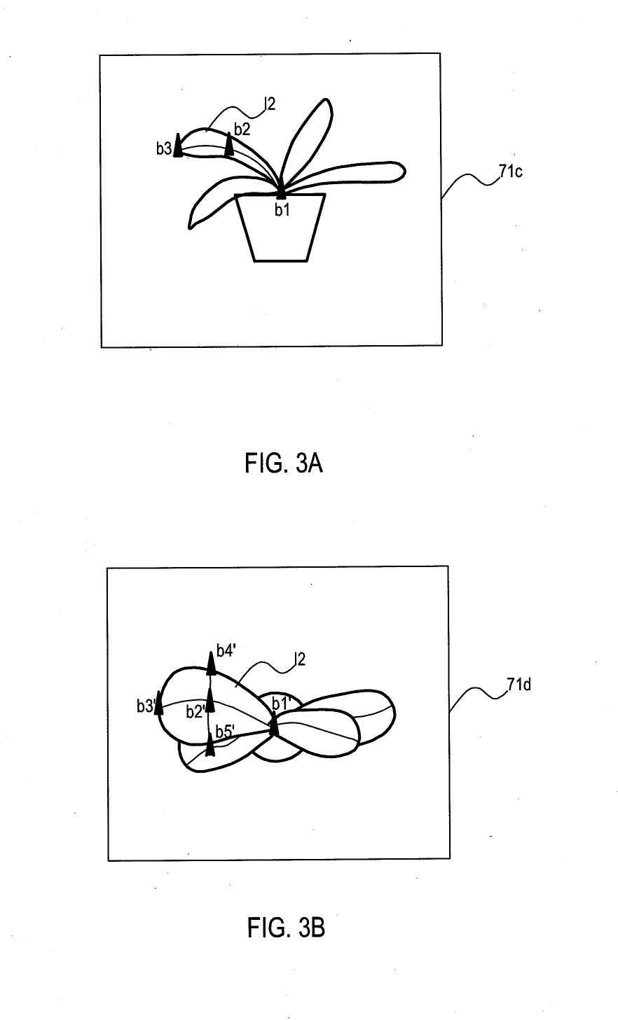

(2) A curve formed by connecting at least three measurement points 72. In FIG. 3A, it is a second schematic front view image of a plant according to an embodiment of the present invention, where a measurement point b1, a measurement point b2 and a measurement point b3 are connected to form a curve. In FIG. 3B, it is a second schematic top view image of a plant according to an embodiment of the present invention, where a measurement point b4′, a measurement point b2′ and a measurement point b5′ are connected to form a curve.

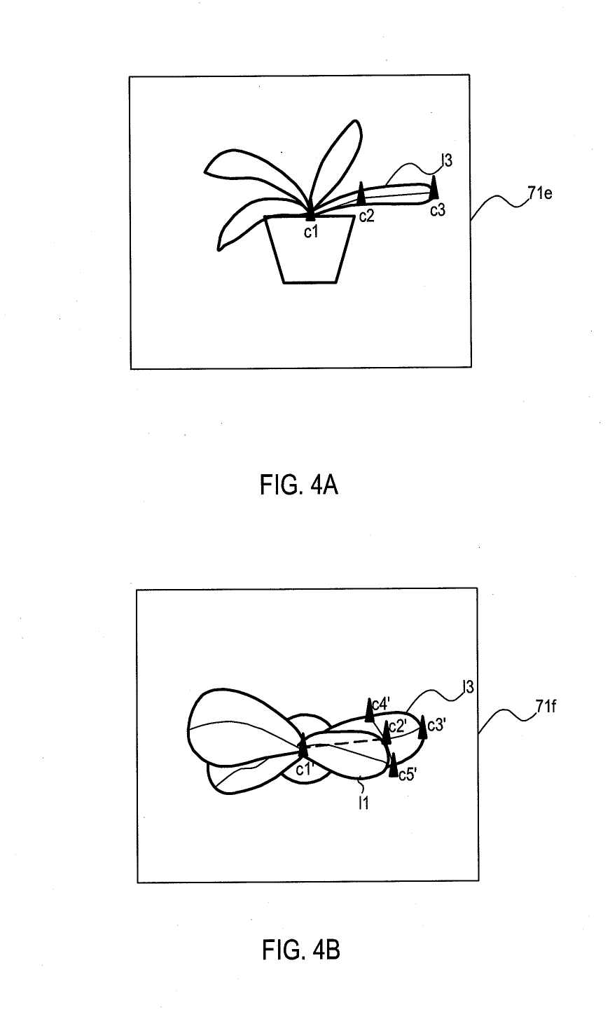

(3) A polygonal segment formed by connecting at least three measurement points. In FIG. 4A, it is a third schematic front view image of a plant according to an embodiment of the present invention, where a measurement point c1, a measurement point c2 and a measurement point c3 are connected to form a polygonal segment. In FIG. 4B, it is a third schematic top view image of a plant according to an embodiment of the present invention, where a measurement point c4′, a measurement point c2′ and a measurement point c5′ are connected to form a polygonal segment.

Furthermore, at least three measurement points 72 may be connected to form a closed area or a polygon. However, the present invention is not limited thereto, and the same or similar relations apply.

The computing module 30 calculates at least one piece of plant features 74 of each of the plant images 71 according to the measurement points 72 specified on the plant image 71 and the relation 73 between the measurement points 72. As shown in FIG. 2A, the computing module 30 calculates the length of the straight line formed by connecting the measurement point a1 and the measurement point a2 according to coordinate locations of the measurement point a1 and the measurement point a2 in the plant image 71a, where the length of the straight line represents the length of a leaf 11. As shown in FIG. 2B, the computing module 30 calculates the length of the straight line formed by connecting the measurement point a3′ and the measurement point a4′ according to coordinate locations of the measurement point a3′ and the measurement point a4′ in the plant image 71b, where the length of the straight line represents the width of the leaf 11. Likewise, as shown in FIG. 3A, the computing module 30 obtains the length of a leaf 12 according to the measurement point b1, the measurement point b2 and the measurement point b3. As shown in FIG. 3B, the computing module 30 obtains the width of the leaf 12 according to the measurement point b4′, the measurement point b2′ and the measurement point b5′. As shown in FIG. 4A, the computing module 30 obtains the length of a leaf 13 according to the measurement point c1, the measurement point c2 and the measurement point c3. As shown in FIG. 4B, the computing module 30 obtains the width of the leaf 13 according to the measurement point c4′, the measurement point c2′ and the measurement point c5′. Moreover, the plant features may also be an overall height of the plant, a leaf area or the like, but the present invention is not limited thereto.

Further, the number of the plant images 71 may be two or more, and a plurality of plant images 71 may correspond to the same plant. For example, the plant images 71 include a first plant image and a second plant image, which may be plant images of the same plant at different time points, or plant images of the same plant at different angles. The measurement specifying module 20 specifies at least two measurement points 72 on the first plant image, and the measurement points 72 at least include a first measurement point of the first plant image and a second measurement point of the first plant image. The measurement specifying module 20 specifies at least two measurement points 72 on the second plant image, and the measurement points 72 at least include a first measurement point of the second plant image and a second measurement point of the second plant image. There is a corresponding relation between the first measurement point of the first plant image and the first measurement point of the second plant image, and there is a corresponding relation between the second measurement point of the first plant image and the second measurement point of the second plant image. The computing module 30 calculates at least one piece of plant features 74 of the first plant image according to the measurement points and the relation between the measurement points of the first plant image, the corresponding relation between the first measurement point of the first plant image and the first measurement point of the second plant image, and the corresponding relation between the second measurement point of the first plant image and the second measurement point of the second plant image.

For example, since the leaf is three-dimensional (3D) in space, if the length of the leaf is calculated using a single two-dimensional (2D) image, the accuracy is not high; while if a 2D image captured at another angle can be integrated, 3D coordinate values can be obtained, so as to calculate an accurate length of the leaf. Referring to FIG. 2A and FIG. 2B, the plant image 71a is considered as the first plant image, and the plant image 71b is considered as the second plant image. The measurement point a1 and the measurement point a2 specified by the measurement specifying module 20 on the plant image 71a are respectively considered as the first measurement point of the first plant image and the second measurement point of the first plant image, and the measurement point a1′ and the measurement point a2′ specified by measurement specifying module 20 on the plant image 71b are respectively considered as the first measurement point of the second plant image and the second measurement point of the second plant image. The computing module 30 calculates the length of the leaf 11 in the plant image 71a according to the relation between the measurement point a1 and the measurement point a2, the corresponding relation between the measurement point a1 and the measurement point a1′, and the corresponding relation between the measurement point a2 and the measurement point a2′.

For another example, referring to FIG. 3A and FIG. 3B, the plant image 71c is considered as the first plant image, and the plant image 71d is considered as the second plant image. The measurement point b1, the measurement point b2 and the measurement point b3 specified by the measurement specifying module 20 on the plant image 71c are respectively considered as the first measurement point of the first plant image, the second measurement point of the first plant image and a third measurement point of the first plant image, and the measurement point b1′, the measurement point b2′ and the measurement point b3′ specified by the measurement specifying module 20 on the plant image 71d are respectively considered as the first measurement point of the second plant image, the second measurement point of the second plant image and a third measurement point of the second plant image. The computing module 30 calculates the length of the leaf 12 in the plant image 71c or the plant image 71d according to the relation between the measurement point b1, the measurement point b2 and the measurement point b3, the corresponding relation between the measurement point b1 and the measurement point b1′, the corresponding relation between the measurement point b2 and the measurement point b2′, and the corresponding relation between the measurement point b3 and the measurement point b3′.

For still another example, referring to FIG. 4A and FIG. 4B, the plant image 71e is considered as the first plant image, and the plant image 71f is considered as the second plant image. The measurement point c1, the measurement point c2 and the measurement point c3 specified by the measurement specifying module 20 on the plant image 71e are respectively considered as the first measurement point of the first plant image, the second measurement point of the first plant image and a third measurement point of the first plant image, and the measurement point c1′, the measurement point c2′ and the measurement point c3′ specified by the measurement specifying module 20 on the plant image 71f are respectively considered as the first measurement point of the second plant image, the second measurement point of the second plant image and a third measurement point of the second plant image.

The plant image 71f includes a hidden part, that is, the leaf 13 is partially blocked by the leaf 11, and therefore, the shape of the whole leaf 13 cannot be seen in the plant image 71e and the plant image 71f. The user may control the measurement specifying module 20 (which, for example, provides the measurement specifying interface 21) to specify the measurement point c1′, the measurement point c2′ and the measurement point c3′ corresponding to the leaf 13. The computing module 30 estimates plant feature of the hidden part as an estimated length of the leaf 13 in the plant image 71f according to coordinates of the measurement point c1′, the measurement point c2′ and the measurement point c3′ in the plant image 71f and the relation between the measurement point c1′, the measurement point c2′ and the measurement point c3′. However, the use of the relation depends on a demand of the user, and is not limited in the present invention.

In some embodiments, the storage module 40 not only stores the plant image 71, but also stores the measurement points 72 and the relation 73 between the measurement points 72 corresponding to each of the plant images 71, and the plant features 74 corresponding to each of the plant images 71. Therefore, when presenting the plant image 71, the image display module 10 also presents the measurement points 72 corresponding to the plant image 71, the relation 73 between the measurement points 72, and the plant features 74.

Through the measurement specifying module 20 (which, for example, provides the measurement specifying interface 21), the user may adjust the measurement points 72 to form a plurality of subsequent measurement points, and adjust the relation between two or more subsequent measurement points. Adjustment methods include adding and deleting subsequent measurement points, and correcting the positions and the relation of subsequent measurement points. The computing module 30 calculates a piece of plant features according to the adjusted subsequent measurement points and the relation between the subsequent measurement points.

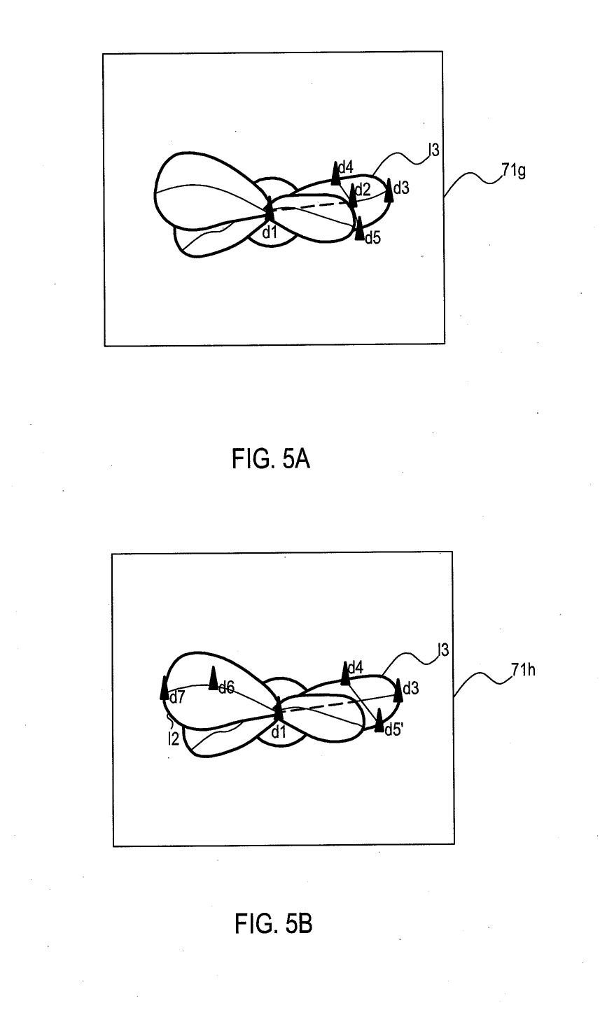

FIG. 5A and FIG. 5B are schematic views illustrating specifying of subsequent measurement point according to an embodiment of the present invention. The plant image 71g is an image before measurement point adjustment. The user adjusts measurement points on the plant image 71g through the measurement specifying module 20, for example, deletes a measurement point d2, corrects the position of a measurement point d5 to form a measurement point d5′, and adds measurement points d6 and d7 on the leaf 12. A relation between a measurement point d4 and the measurement point d5 is corrected from a polygonal segment to a straight line, a relation between a measurement point d1 and a measurement point d3 is corrected from a polygonal segment to a straight line, and a relation between a measurement point d1, the measurement point d6 and the measurement point d7 is specified to a curve. The plant image 71g is adjusted to form a plant image 71h, and the measurement points on the plant image 71h are considered as subsequent measurement points. The computing module 30 recalculates the length and width of the leaf 13 and calculates the length of the leaf 12, that is, the plant features according to the subsequent measurement points and the relation thereof described above, according to the subsequent measurement points and the relation between the subsequent measurement points.

FIG. 6 is a schematic view of a system for measuring features of plant by plant images according to a third embodiment of the present invention. In this embodiment, the functions and descriptions of modules that are the same as those in the foregoing embodiments are as described above, and the details will not be described again.

The storage module 40 stores at least one corresponding species 75, and data about recommended measurement points 76 and a relation 77 thereof respectively corresponding to each of the corresponding species 75. The measurement specifying module 20 may obtain the recommended measurement points 76 corresponding to the corresponding species 75 and their relation 77 between the recommended measurement points 76 from the storage module 40 according to the plant image 71 which corresponds to one of at least one corresponding species 75 (for example, the corresponding species 75 corresponding to the plant image 71 is recognized by using an image recognition technology 22, or the corresponding species 75 is input by the user or preset). The measurement specifying module 20 specifies the recommended measurement points 75 and the relation 77 between the recommended measurement points 76 on the plant image 71 as the measurement points 72 and the relation 73 that are described above. Then, the user may further control, operate on and adjust, through the measurement specifying interface 21, the specifying and adjustment of the measurement points 72 and the relation 73 on the plant image 71. Further, since plants of the same species have highly similar plant images and the same plant features to be measured, data about the recommended measurement points 76 and the relation 77 of each of the corresponding species 75 may be created in advance, and after the species of the plant image is recognized by using the image recognition technology 22 or the corresponding species of the plant image 71 is specified by the user through the measurement specifying module 20 (which, for example, provides the measurement specifying interface 21), the measurement specifying module 20 can find, according to the data about the recommended measurement points 76 and the relation 77 thereof (for example, the recommended measurement points 76 are the tip, middle point and root of the topmost leaf, and the relation 77 is a polygonal line formed by connecting the tip, middle point and root), three proper and corresponding measurement points 72 and the polygonal line in the plant image 71 as relation data.

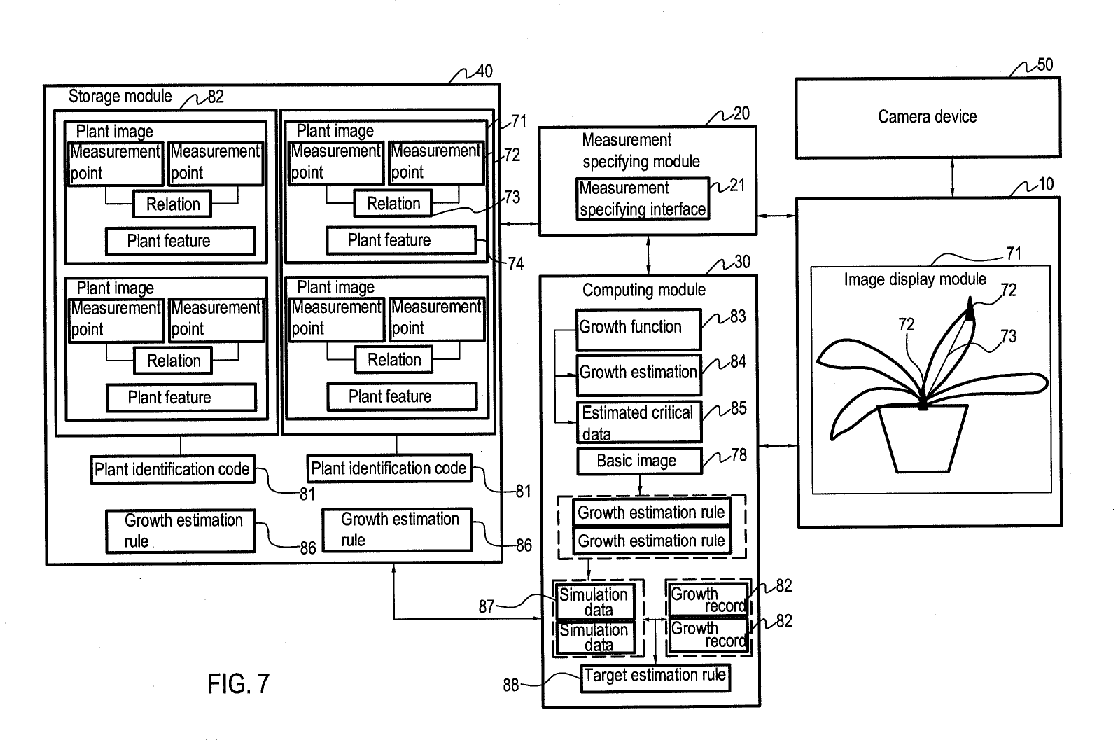

FIG. 7 is a schematic view of a system for measuring features of plant by plant images according to a fourth embodiment of the present invention. Different from the foregoing embodiments, each plant corresponds to a plant identification code 81, and each plant identification code 81 corresponds to one or more growth records 82. The growth record(s) 82 include a plurality of the plant images 71 corresponding to each plant identification code 82 in different growth periods of the plant, measurement points 72 on each of the plant images 71 and a relation 73 between the measurement points 72, and plant features 74 corresponding to the plant image 71. The plant identification codes 81 and the growth records 82 are stored in the storage module 40. The computing module 30 calculates a growth function 83 of a plant to which a plant identification code 81 belongs according to the plant features 74 corresponding to the plant images 71 of the plant identification code 81 in different growth periods.

Further, the computing module 30 may calculate a growth estimation 84 of the plant to which the plant identification code 81 belongs according to the growth function 83, that is, calculates the growth trend of the plant in future. Furthermore, the computing module 30 may calculate estimated critical data of the plant features 74 of the plant to which the plant identification code 81 belongs according to the growth function 83, that is, possible limits of plant growth, for example, estimate the maximum leaf length, the maximum leaf width and the maximum flower area.

Moreover, the storage module 40 further records a plurality of growth estimation rules 86 (for example, estimating the growth trend by trajectory tracking, and estimating the growth length based on the displacement of measurement points). The computing module first selects a basic image 78 from a plurality of plant images 81 corresponding to a single plant identification code 81. The computing module 30 introduces at least one of the positions of the measurement points 72 and the relation 73 of the basic image 78 and the plant features 74 corresponding to the basic image 78 into all of the growth estimation rules 86, so as to obtain a plurality of pieces of simulation data 87 corresponding to each of the growth estimation rules 86. The simulation data 87 corresponds to different growth periods of the plant to which the plant identification code 81 belongs. Then, the computing module 30 compares the simulation data 87 and the growth records 82 to obtain a desired target estimation rule 88 from all of the growth estimation rules. Afterward, the computing module 30 introduces the growth function 83 corresponding to the plant identification code 81 into the target estimation rule 88, so as to obtain the growth estimation 84 described above.

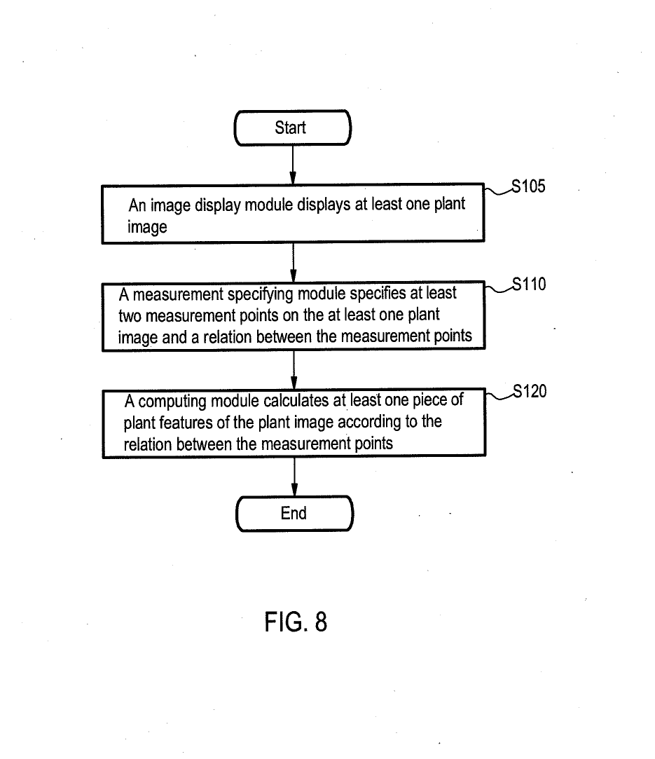

FIG. 8 is a schematic flowchart of a method for measuring features of plant by plant images according to an embodiment of the present invention. Referring to FIG. 1 to FIG. 7 and FIG. 8, this method at least includes the following steps:

An image display module displays at least one plant image (Step S105), and then a measurement specifying module specifies at least two measurement points on the at least one plant image and a relation between the measurement points (Step S110). This step may be performed in at least the following manners:

(1) As shown in FIG. 1A, the image display module 10 presents one or more plant images 71. The measurement specifying module 20 is used for specifying the measurement points 72 on each of the plant images 71 and the relation 73 between the measurement points 72, and specifying a corresponding relation between the measurement points 72 on the plant images 71.

(2) In some embodiments, as shown in FIG. 1B, the measurement points 72, the relation 73 between the measurement points 72 and the plant features 74 are already specified on the plant image 71 presented by the image display module 10. The measurement points 72 are directly read from the storage module 40 by the measurement specifying module 20. In some other embodiments, as shown in FIG. 6, the storage module 40 stores data about recommended measurement points 76 and a relation 77 thereof respectively corresponding to a plurality of corresponding species 75. The measurement specifying module 20 recognizes the corresponding species 75 corresponding to the plant image 71 by using an image recognition technology 22, so as to obtain the related recommended measurement points 76 and relation 77 to specify measurement points on the plant image 71.

Afterward, when the user examines the measurement points 72, the relation 73 and the plant features 74 of the plant image 71, and intends to correct the data, the user may input a control instruction through the measurement specifying interface 21. The measurement specifying module 20 allows the user to adjust the measurement points 72 to form a plurality of subsequent measurement points and the relation between the subsequent measurement points through the measurement specifying interface 21 only after obtaining the control instruction.

A computing module calculates at least one piece of plant features of the plant image according to the relation between the measurement points (Step S120). This step is performed corresponding to the manner in which Step S110 is performed. If Step S110 is performed in the manner (1), in this step, the computing module 30 calculates the plant features 74 according to the measurement points 72 on the plant image 71 and the relation 73 between the measurement points 72. If Step S110 is performed in the manner (2), the computing module 30 calculates at least one piece of plant features according to the adjusted subsequent measurement points and relation, and stores the subsequent measurement points and the relation between the subsequent measurement points, and the plant features, so as to correspond to the plant image 71. In some embodiments, the plant image 71 includes a hidden part, and the computing module 30 estimates plant feature corresponding to the hidden part according to the specified measurement points 72 and the relation 73 between the measurement points 72.

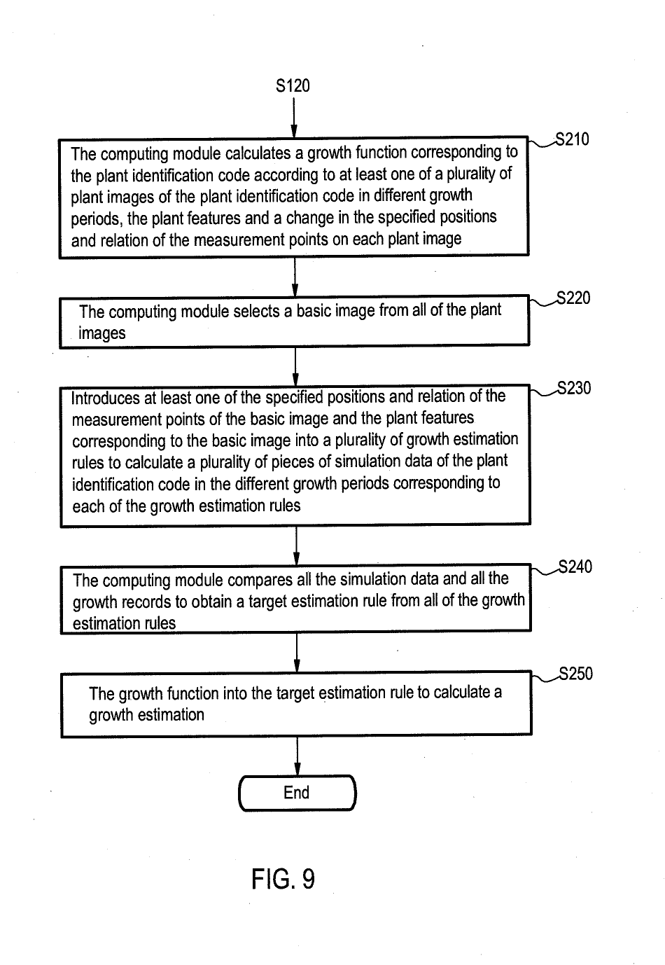

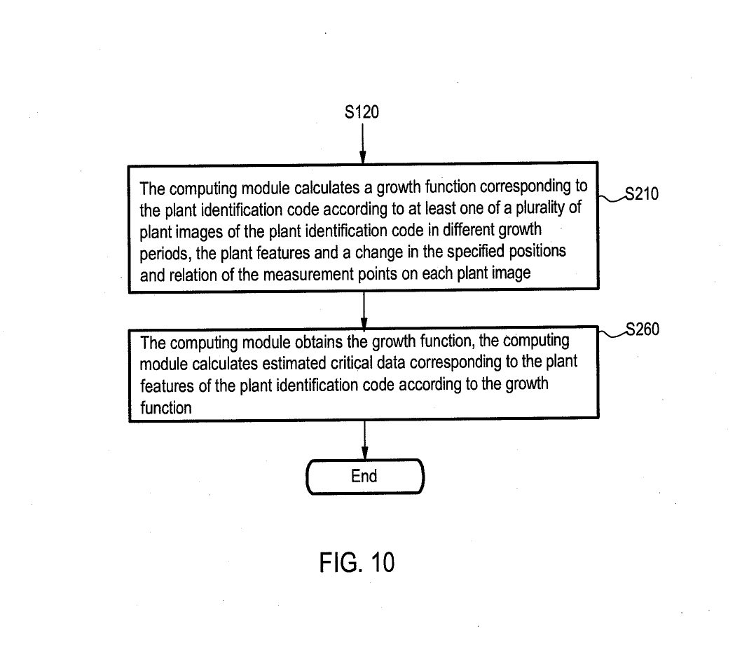

FIG. 9 and FIG. 10 are schematic subsequent flowcharts of a method for measuring features of plant by plant images according to an embodiment of the present invention. Referring to FIG. 7, FIG. 9 and FIG. 10, the storage module stores a plurality of growth estimation rules, and a plurality of growth records corresponding to each of the plant identification codes. This method includes the following steps:

The computing module 30 calculates a growth function 83 corresponding to the plant identification code 81 according to at least one of a plurality of plant images 71 of the plant identification code 81 in different growth periods, the plant features 74 and a change in the specified positions and relation 73 of the measurement points 72 on each plant image 71 (Step S210).

Then, the computing module 30 selects a basic image 78 from all of the plant image 71 (Step S220), and introduces at least one of the specified positions and relation of the measurement points 71 of the basic image 78 and the plant features corresponding to the basic image 78 into a plurality of growth estimation rules 86 to calculate a plurality of pieces of simulation data 87 of the plant identification code 81 in the different growth periods corresponding to each of the growth estimation rules 86 (Step S230). Afterward, the computing module 30 compares all the simulation data 87 and all the growth records 82 to obtain a target estimation rule 88 from all of the growth estimation rules 86 (Step S240), and then introduces the growth function 83 into the target estimation rule 88 to calculate a growth estimation 84 (Step S250).

Alternatively, after Step S210 is completed, and the computing module 30 obtains the growth function 83, the computing module 30 calculates estimated critical data 85 corresponding to the plant features 74 of the plant identification code 81 according to the growth function 83 (Step S260).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for measuring features of plant by plant images, comprising:
an image display module, for displaying at least one plant image;
a measurement specifying module, for specifying at least two measurement points on each of the plant images and the relation between the at least two measurement points; and
a computing module, for calculating at least one piece of plant features of the at least one plant image according to the at least two measurement points and the relation between the at least two measurement points.

2. The system for measuring features of plant by plant images according to claim 1, wherein the relation between measuring points could be a straight line formed by connecting two of the measurement points, a curve formed by connecting at least three of the measurement points, a polygonal segment formed by connecting at least three of the measurement points, a closed area formed by connecting at least three of the measurement points.

3. The system for measuring features of plant by plant images according to claim 1, wherein the image display module is further used for displaying the at least one plant image, the measurement points corresponding to the at least one plant image and the relation thereof, and the plant features corresponding to the at least one plant image, the measurement specifying module is further used for adjusting the displayed measurement points to form subsequent measurement points and modifying the relation between the at least two subsequent measurement points, and the computing module is further used for calculating at least one piece of plant features according to the subsequent measurement points and the relation thereof.

4. The system for measuring features of plant by plant images according to claim 1, further comprising a storage module, for storing the at least one corresponding species, recommended measurement points respectively corresponding to each of the corresponding species and the relation of measurement points thereof, and the measurement specifying module obtains the corresponding recommended measurement points and their relation thereof according to the corresponding species for at least one plant image, so as to specify, on the at least one plant image, at least two measurement points and a relation between the at least two measurement points.

5. The system for measuring features of plant by plant images according to claim 1, wherein the measurement specifying module provides a measurement specifying interface for a user to operate on the at least one plant image to specify at least two measurement points and a relation between the at least two measurement points.

6. The system for measuring features of plant by plant images according to claim 1, wherein the at least one plant image comprises a first plant image and a second plant image, the measurement specifying module specifies at least two measurement points on the first plant image, and the at least two measurement points of the first plant image at least comprise a first measurement point of the first plant image and a second measurement point of the first plant image; the measurement specifying module is further used for specifying at least two measurement points on the second plant image, wherein the at least two measurement points of the second plant image at least comprise a first measurement point of the second plant image and a second measurement point of the second plant image, and there is a corresponding relation between the first measurement point of the first plant image and the first measurement point of the second plant image, and there is a corresponding relation between the second measurement point of the first plant image and the second measurement point of the second plant image; and the computing module calculates at least one piece of plant feature of the first plant image according to at least two measurement points of the first plant image and the relation between the at least two measurement points, the corresponding relation between the first measurement point of the first plant image and the first measurement point of the second plant image, and the corresponding relation between the second measurement point of the first plant image and the second measurement point of the second plant image.

7. The system for measuring features of plant by plant images according to claim 1, further comprising a storage module, for storing growth records corresponding to a plant identification code, wherein the growth records comprise plant images corresponding to the plant identification code in different growth periods, at least two measurement points on each of the plant images and a relation between the at least two measurement points, and plant features corresponding to each of the plant images, and the computing module is further used for calculating a growth function corresponding to the plant identification code according to the plant features corresponding to the plant images of the plant identification code in different growth periods.

8. The system for measuring features of plant by plant images according to claim 7, wherein the computing module is further used for growth estimation corresponding to the plant identification code according to the growth function.

9. The system for measuring features of plant by plant images according to claim 1, wherein the plant image comprises a hidden part, and the computing module is further used for estimating at least one piece of plant feature corresponding to the hidden part according to the at least two measurement points and the relation between the at least two measurement points.

10. A method for measuring features of plant by plant images, comprising:
displaying at least one plant image by an image display module;
specifying at least two measurement points on the at least one plant image and the relation between the at least two measurement points by a measurement specifying module; and
calculating at least one piece of plant features of the plant image according to the relation between the at least two measurement points by a computing module.

11. The method for measuring features of plant by plant images according to claim 10, wherein the relation between measuring points could be a straight line formed by connecting two of the measurement points, a curve formed by connecting at least three of the measurement points, a polygonal segment formed by connecting at least three of the measurement points, a closed area formed by connecting at least three of the measurement points.

12. The method for measuring features of plant by plant images according to claim 10, wherein the step of specifying at least two measurement points on the at least one plant image and the relation between the at least two measurement points by a measurement specifying module is adjusting the displayed measurement points to form a plurality of subsequent measurement points and specifying the relation between the at least two subsequent measurement points according to a control instruction by the measurement specifying module; and the step of calculating at least one piece of plant features of the plant image according to the relation between the at least two measurement points by a computing module is calculating at least a piece of plant features according to the subsequent measurement points and the relation thereof by the computing module.

13. The method for measuring features of plant by plant images according to claim 10, further comprising: storing a plurality of growth records corresponding to a plant identification code of the plant image by a storage module, wherein the growth records comprise a plurality of the plant images corresponding to the plant identification code in different growth periods, at least two measurement points on each of the plant images and the relation between the at least two measurement points, and plant features corresponding to each of the plant images, and the step of calculating at least one piece of plant features of the plant image according to the relation between the at least two measurement points by a computing module further comprises:
calculating a growth function corresponding to the plant identification code according to at least one of the plant images of the plant identification code in the different growth periods, the plant features and a change in the specified positions and relation of the measurement points on each of the plant image, by the computing module.

14. The method for measuring features of plant by plant images according to claim 13, wherein the storage module further stores a plurality of growth estimation rules, and the method further comprises steps of:
selecting a basic image from the plant images by the computing module;
introducing at least one of the specified positions and relation of the measurement points of the basic image in the plant image and the plant features corresponding to the basic image into a plurality of growth estimation rules to calculate a plurality of pieces of simulation data of the plant identification code in the different growth periods corresponding to each of the growth estimation rules by the computing module;
comparing the simulation data and the growth records to obtain a target estimation rule from the growth estimation rules by the computing module; and
introducing the growth function into the target estimation rule to calculate a growth estimation by the computing module.

15. The method for measuring features of plant by plant images according to claim 10, wherein the plant image comprises a hidden part, and the step of calculating at least one piece of plant features of the plant image according to the relation between the at least two measurement points by a computing module further comprises:
estimating at least one growth estimation corresponding to the hidden part according to the at least two measurement points and the relation between the at least two measurement points by the computing module.

16. A recording medium, storing a program code readably by an electronic device, wherein when reading the program code, the electronic device performs a method for measuring features of plant by plant images, which comprises steps of:
displaying at least one plant image by an image display module;
specifying at least two measurement points on the at least one plant image and the relation between the at least two measurement points by a measurement specifying module; and
calculating at least one piece of plant features of the plant image according to the relation between the at least two measurement points by a computing module.
